(19) United States
(12) Patent Application Publication
(10) Pub. No.: US 2026/0342604 A1
(43) Pub. Date: Oct. 29, 2026

(54) ADAPTIVE SUMMARIES FOR LATE JOINERS IN ONGOING EVENTS

(71) Applicant: MICROSOFT TECHNOLOGY LICENSING, LLC, Redmond, WA (US)

(72) Inventor: Mrinal Kumar SHARMA, Noida (IN)

(21) Appl. No.: 19/188,761

(22) Filed: Apr. 24, 2025

(51) Int. Cl. H04L 12/18; H04L 51/063; H04L 65/613

(52) U.S. Cl. CPC H04L 12/1831; H04L 51/063; H04L 65/613

(57) ABSTRACT

The techniques disclosed herein are directed to generating recap summaries for an ongoing event (e.g., an online meeting, a podcast) that are customized for late-joining users. As mentioned above, generative artificial intelligence-based productivity tools are often used for summarizing audiovisual content such a text document, an online meeting, and the like. However, many existing artificial intelligence systems lack the ability to adapt summary outputs to suit the needs of individual users leading to a frustrating user experience. In contrast, the present system and method provides mechanisms for customizing the retrieval of audiovisual content corresponding to an elapsed portion of an ongoing event based on the time of entry of a late-joining user thereby enabling adaptive recap summaries. Moreover, the content of the summaries can be further customized based on contextual information such as a user’s role (e.g., a job title) thereby ensuring helpful recap summaries.

### BACKGROUND

Recent times have seen the proliferation of generative artificial intelligence-based productivity tools. Examples include tools for combing through massive amounts of unstructured data for analytics, generating text content for automated email answering, and implementing automated software testing suites. One particularly common use case is summarizing audiovisual content such a text document, an online meeting, and the like. In one example, a user that is overwhelmed with unread emails can invoke an artificial intelligence model to analyze their inbox and generate an organized summary. In another example, an online meeting application can include features for generating transcripts, meeting notes, and summaries that enable users to quickly gather and digest content.

However, many artificial intelligence systems utilize a linear, one-size-fits-all format. That is, many artificial intelligence systems merely summarize the content that is fed into them without regard for broader contextual information and/or user preferences. For instance, a user may be ten minutes late to an online meeting. Consequently, the other attendees of the online meeting may already be deep into a discussion. Out of respect for their colleagues, the user may refrain from interrupting the meeting to ask questions leaving the user lost and/or confused. In addition, the user then spends extra time after the meeting reading notes, transcripts, and/or generated summaries to catch up. Unfortunately, due to the linear, one-size-fits-all format, the user must manually locate the portions of the meeting they missed resulting in an inefficient and/or frustrating user experience.

It is with respect to these and other considerations that the disclosure made herein is presented.

### SUMMARY

The techniques described herein are directed to generating recap summaries for an ongoing event (e.g., an online meeting, a podcast) that are customized for late-joining users. As mentioned above, generative artificial intelligence-based productivity tools are often used for summarizing audiovisual content such a text document, an online meeting, and the like. However, many existing artificial intelligence systems lack the ability to adapt summary outputs to suit the needs of individual users. For example, a user may be ten minutes late to an online meeting. Consequently, the other attendees of the online meeting may already be deep into a discussion. Out of respect for their colleagues, the user may refrain from interrupting the meeting to ask questions leaving the user lost and/or confused. In addition, the user then spends extra time after the meeting reading notes, transcripts, and/or generated summaries to catch up. Unfortunately, due to the linear, one-size-fits-all format, the user must manually locate the portions of the meeting they missed resulting in an inefficient and/or frustrating user experience.

To address this technical challenge, the present system and method provides mechanisms for customizing the retrieval of audiovisual content corresponding to an elapsed portion of an ongoing event based on the time of entry of a late-joining user thereby enabling adaptive recap summaries. In various examples, the system can detect an entry input to an ongoing event that (i) is received from a computing device (e.g., a laptop, a tablet, a smartphone) associated with a user identifier and (ii) includes a timestamp indicating a time at which the entry input was generated. In this way, the system can determine the time of entry of a late-joining user. In response, the user can be served an audiovisual feed of the ongoing event (e.g., a speech audio feed, a webcam feed).

Accordingly, the system determines an elapsed portion of the ongoing event based on the timestamp of the entry input and a start time of the ongoing event. For example, if an online meeting was scheduled to start at 10:00 AM and the timestamp of the entry input was 10:22 AM, the elapsed portion of the ongoing event is the first twenty-two minutes. Once, the elapsed portion of the ongoing event is determined, the system retrieves audiovisual content corresponding to the elapsed portion for summarization. In various examples, the amount of audiovisual content that the system retrieves is configured in accordance with a threshold duration. For example, if a late-joining user is an hour late to a meeting, they may only need a summary of the last ten minutes to catch up to the current discussion with the other fifty minutes available for review after the meeting.

The system then executes a computational model on the retrieved audiovisual content to produce a recap summary that identifies one or more semantic topics conveyed by the audiovisual content. In various examples, the computational model is a language model (e.g., a large language model, a small language model, a multimodal language model) that leverages characteristically strong language processing performance to identify semantic topics from the audiovisual content. However, it should be understood that the computational model can be any suitable tool for processing and reasoning about audiovisual content. Furthermore, as will be elaborated upon below, the content of the recap summary can be customized based on contextual information associated with the user identifier (e.g., a role).

The system can then pause the audiovisual feed of the ongoing event and deliver the recap summary to the late-joining user in an integrated user interface element. In various examples, delivering the recap summary can be accomplished using different output modalities. In one example, the computational model is configured to output a text file describing the semantic topics conveyed by the audiovisual content. In an alternative example, the computational model is configured to synthesize a narration of the recap summary that the user can listen to. Moreover, the integrated user interface can be a private chat message that the user can open to receive the recap summary. In another example, the integrated user interface is an overlay on the ongoing event user interface that is rendered as the late-joining user arrives prompting them to quickly catch up to the current discussion.

After delivering the recap summary, the system then resynchronizes the late-joining user’s computing device to the ongoing event and resumes the audiovisual feed. For instance, in an online meeting, the late-joining user is resynchronized to the live discussion and can proceed to interact with the other attendees. Conversely, in a podcast, once the recap summary concludes, the podcast resumes from where it was paused thereby ensuring a seamless listening experience.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for generating and delivering a recap summary of an ongoing event to a late-joining user.

FIG. 2 is an illustration of an example user interface for delivering a recap summary of an ongoing event in an auditory format using an overlay user interface element.

FIG. 3 is an illustration of an example user interface for delivering a recap summary of an ongoing event in both an auditory format and a textual format using an overlay user interface element.

FIG. 4 is an illustration of an example user interface for delivering a recap summary of an ongoing event using a private message user interface element.

FIG. 5 is a flow diagram showing aspects of a process for generating and delivering a recap summary for an ongoing event.

FIG. 6 is a computer architecture diagram illustrating an illustrative computer hardware and software architecture for a computing system capable of implementing aspects of the techniques and technologies presented herein.

### DETAILED DESCRIPTION

The techniques described herein are directed to generating recap summaries for an ongoing event (e.g., an online meeting, a podcast) that are customized for late-joining users. As mentioned above, generative artificial intelligence-based productivity tools are often used for summarizing audiovisual content such a text document, an online meeting, and the like. However, many existing artificial intelligence systems lack the ability to adapt summary outputs to suit the needs of individual users. For example, a user may be ten minutes late to an online meeting. Consequently, the other attendees of the online meeting may already be deep into a discussion. Out of respect for their colleagues, the user may refrain from interrupting the meeting to ask questions leaving the user lost and/or confused. In addition, the user then spends extra time after the meeting reading notes, transcripts, and/or generated summaries to catch up. Unfortunately, due to the linear, one-size-fits-all format, the user must manually locate the portions of the meeting they missed resulting in an inefficient and/or frustrating user experience. To address this technical challenge, the present system and method provides mechanisms for customizing the retrieval of audiovisual content corresponding to an elapsed portion of an ongoing event based on the time of entry of a late-joining user thereby enabling adaptive recap summaries.

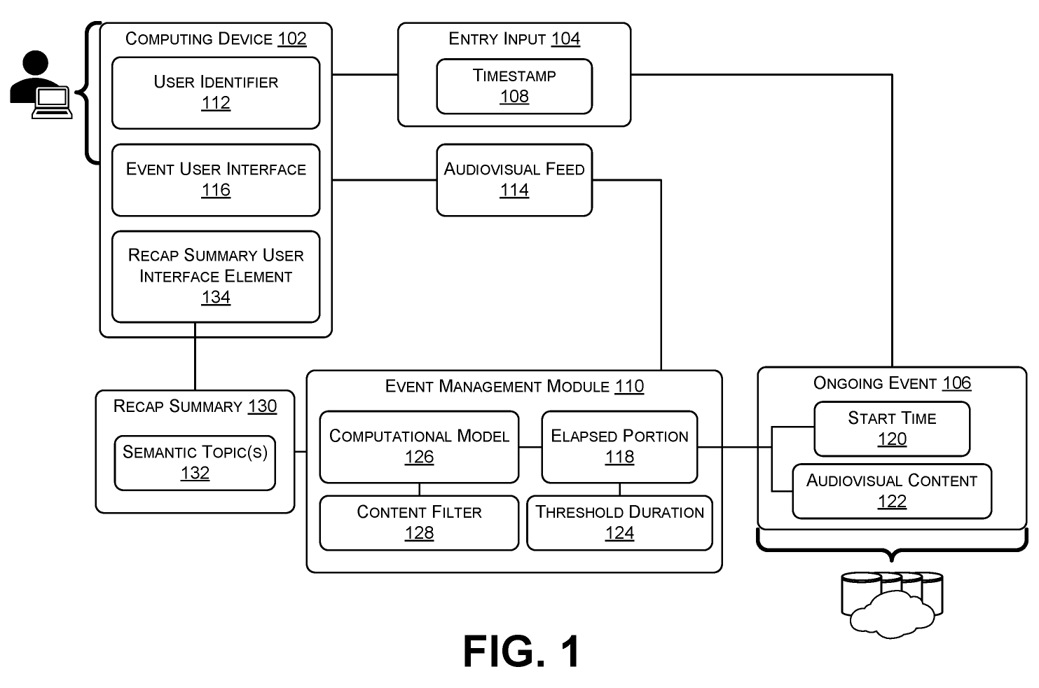

Various examples, scenarios, and aspects related to the techniques are described below with respect to FIGS. 1-6.

FIG. 1 illustrates an environment in which a user at a personal computing device 102 (e.g., a laptop, a smartphone, a tablet) generates an entry input 104 to join an ongoing event 106. Within the context of the present disclosure, an ongoing event 106 is any online event in which a plurality of users gather in a live setting to speak, listen to, and/or share content (e.g., text, images, videos) and are typically hosted remotely (e.g., in a cloud service). However, the present techniques may also be implemented in a peer-to-peer system. Examples of an ongoing event 106 include online meetings, livestreams, voice calls, podcast listening sessions, and the like. Accordingly, an entry input 104 is any user input to the computing device 102 that grants access to the ongoing event 106 such as clicking a “join meeting” button. In various examples, the entry input 104 also includes a timestamp 108 recording the time at which the entry input 104 was generated.

Consequently, an event management module 110 hosting the ongoing event 106 (e.g., in a cloud service operating on server(s) of a cloud-platform) detects that the entry input 104 was received from a computing device 102 that is associated with a specific user identifier 112 (e.g., a username). In this way, the timestamp 108 and the user identifier 110 serve to record a user’s time of entry to the ongoing event 106. In response, the event management module 110 begins serving an audiovisual feed 114 of the ongoing event 106 (e.g., speech audio, webcam video, multimedia content) to the computing device 102 via an event user interface 116. In addition, the event management module 110 calculates an elapsed portion 118 of the ongoing event 106 based on the timestamp 108 and a start time 120 of the ongoing event 106. For example, given a start time 120 of “10:00 AM” and a timestamp 108 of “10:15 AM”, the elapsed portion 118 is fifteen minutes.

Accordingly, the event management module 110 retrieves audiovisual content 122 from the ongoing event 106 corresponding to the elapsed portion 118. In some examples, the event management module 110 retrieves audiovisual content 122 for the full elapsed portion 118 of the ongoing event 106 (e.g., fifteen minutes, thirty minutes). Alternatively, the elapsed portion 118 event management module 110 utilizes a threshold duration 124 that is associated with the elapsed portion 118 to limit the amount of audiovisual content 122 to be retrieved. For instance, an especially tardy user may be an hour late to an ongoing event 106. That is, the elapsed portion 118 is one hour. Rather than processing the entire hour of audiovisual content 122, the threshold duration 124 can limit the event management module 110 to the last ten minutes before the user joined. In this way, the user can quickly catch up to the current discussion and review the preceding fifty minutes of the elapsed portion 118 later.

To process the audiovisual content 122, the event management module 110 invokes a computational model 126 for execution. As mentioned above, the computational model 126 is an artificial intelligence model that analyzes the audiovisual content 122 to identify major semantic topics. In a specific example, the computational model 126 is a language model (e.g., a large language model, a small language model, a multimodal language model). Generally described, a language model is a machine learning algorithm implementing a statistical representation of natural language. Accordingly, the language model is trained on large amounts of text data, image data, and/or other data to learn statistical relationships between individual tokens (e.g., words, characters, phrases).

For instance, the language model can be trained to predict tokens in sequences of textual training data. Consequently, the language model achieves predictive capability with respect to vague and/or typically nebulous aspects inherent to natural language such as syntax, semantics, and ontologies. Subsequently, when employed in inference mode, the output of the language model can include new sequences of text that the model generates (e.g., a recap summary output). In this way, language models are especially well-suited for analyzing unstructured data such as the audiovisual content 122.

Moreover, the event management module 110 can invoke the computational model 126 using an input instruction (e.g., a prompt). Generally described, a prompt refers to any input provided to the computational model 126 that causes the computational model 126 to generate an output. A prompt can be provided in various modalities, such as text, an image, audio, video, and so forth. For instance, a “language generation prompt” is an input to the computational model where the requested output is in the form of natural language. Likewise, an “audio generation prompt” is any input to the computational model 126 where the requested output is in the form of an audio file (e.g., an auditory narration). In various examples, a prompt is input to the computational model 126 as a natural language command (e.g., “Generate a summary of the attached transcript and output an auditory narration of the summary”).

Moreover, to improve the efficiency of the computational model 126, the event management module 110 can include a content filter 128 that removes portions of the audiovisual content 122 that are redundant and/or low-priority such as repetition, content with no specific functional and/or informative element (e.g., small talk), and the like. To implement the content filter 128, the event management module 110 can retrieve a transcription of the audiovisual content 122 and parse the transcription using a preconfigured priority metric. In general, the priority metric can quantify the level of semantic content in a given portion of the audiovisual content. In this way, the event management module 110 can identify low-priority and/or irrelevant content that can be filtered out.

After retrieving and/or preprocessing the audiovisual content 122 the event management module 110 invokes an execution of the computational model 126 to generate a natural language recap summary 130 identifying one or more semantic topics 132 that are conveyed in the audiovisual content 122 corresponding to the elapsed portion 118 of the ongoing event. That is, the recap summary 130 is customized for the late-joining user to specifically cover the part of the ongoing event 106 that they missed.

Subsequently, the recap summary 130 is delivered to the computing device 102 via a recap summary user interface element 134 that is integrated into the event user interface 116. In various examples, the recap summary user interface element 134 is configured based on an output modality of the recap summary 130 (e.g., text, auditory narration) and/or a user preference setting. Furthermore, the method of rendering the recap summary user interface element 134 can be customized to user preferences. In one example, the recap summary user interface element 134 is an overlay element that is rendered by modifying the event user interface 116. In another example, the recap summary user interface element 134 is a private message the late-joining user can open to receive the recap summary 130.

As mentioned above, the recap summary 130 can be delivered as an auditory narration of the semantic topics 132 that is synthesized by the event management module 110. Accordingly, the recap summary user interface element 134 can be rendered with audio playback controls (e.g., play/pause, fast forward, rewind), a progress bar, and the like. In another example, the recap summary 130 can be delivered as a text file that the user can read while listening to the ongoing event. Irrespective of the output modality, the content of the recap summary 130 (e.g., the semantic topics 132) can also be selected by the computational model 126 based on contextual information such as a role (e.g., a job title) associated with the user identifier 112 to further customize the recap summary 130 to the specific needs of the user. For example, if the user identifier 112 is associated with a technical role (e.g., a software engineer, a system architect), the computational model 126 can prioritize semantic topics 132 that are relevant to the technical role (e.g., discussion of engineering questions).

Moreover, the event management module 110 can pause the audiovisual feed of the ongoing event 106 to deliver the auditory narration of the recap summary 130 (e.g., playing an auditory narration, rendering a text file). That is, the audiovisual feed 114 is only paused for the late-joining user and not other users of the ongoing event 106. In addition, the event management module 110 may disable certain user input devices (e.g., muting a microphone) while delivering the recap summary 130 to avoid potential disruptions to the ongoing event 106.

After catching the late-joining user up with the recap summary 130, the event management module 110 can resynchronize the computing device 102 with the ongoing event 106 and resume the audiovisual feed 114. In this way, the recap summary 130 is delivered in a seamless format that enables late-joining users to quickly catch up while minimizing interruptions for other users of the ongoing event 106. Furthermore, in the event the late-joining user leaves and rejoins the ongoing event 106, the process can repeat taking into consideration that the user had previously received a recap summary 130. Accordingly, the new recap summary can be further customized to avoid repeating information from the first recap summary 130.

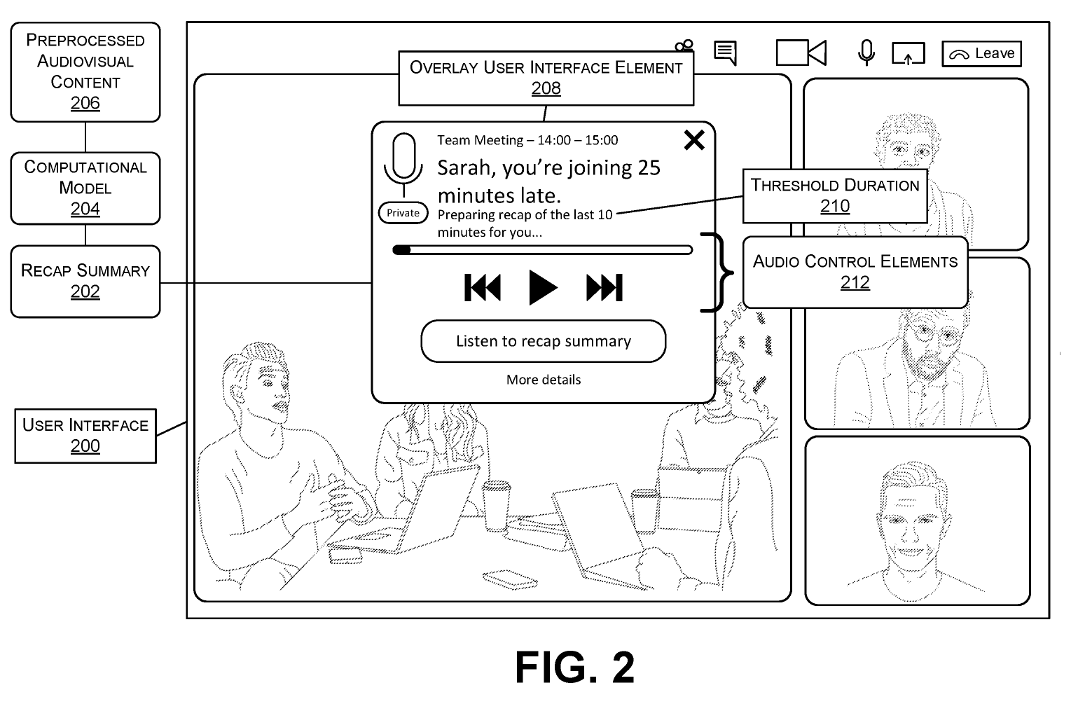

Turning now to FIG. 2, aspects of an example user interface 200 of an ongoing event (e.g., a meeting) for delivering a recap summary 202 are shown and described. As mentioned above, the recap summary 202 is generated by a computational model 204 as a summary of preprocessed audiovisual content 206 corresponding to an elapsed portion of an ongoing event. In various examples, the preprocessed audiovisual content 206 is truncated – if needed – in accordance with a threshold duration then transcribed and filtered as described above to remove irrelevant and/or redundant information.

As shown, the recap summary 202 is delivered by modifying the user interface 200 of the ongoing event to render an overlay user interface element 208. In the present example, as indicated by the overlay user interface element 208, the user is joining the ongoing event twenty-five minutes late. In response, the recap summary 202 covers the last ten minutes prior to the user joining the ongoing event in accordance with a threshold duration 210 as discussed above. In addition, the output modality of the recap summary 202 is an auditory narration. Consequently, the overlay user interface element 208 includes audio control elements 212 for interacting with the recap summary 202.

In various examples, the style of the auditory narration of the recap summary 202 can be configured based on the type of ongoing event presented by the user interface 200. In one example, consider an artificial intelligence podcast session, in which an artificial intelligence model generates the podcast audio. In this situation, the auditory narration of the recap summary 202 can be synthesized using the same virtual voice and/or style of speaking as the artificial intelligence podcast session. That is, the auditory narration of the recap summary 202 is configured with a specific tone, pacing, and manner of speaker to mimic a human narrator. In this way, when the audiovisual feed of the user interface 200 is paused to play the auditory narration of the recap summary, the system can smoothly transition the user audio experience from the recap summary 202 to the resynchronized audiovisual stream.

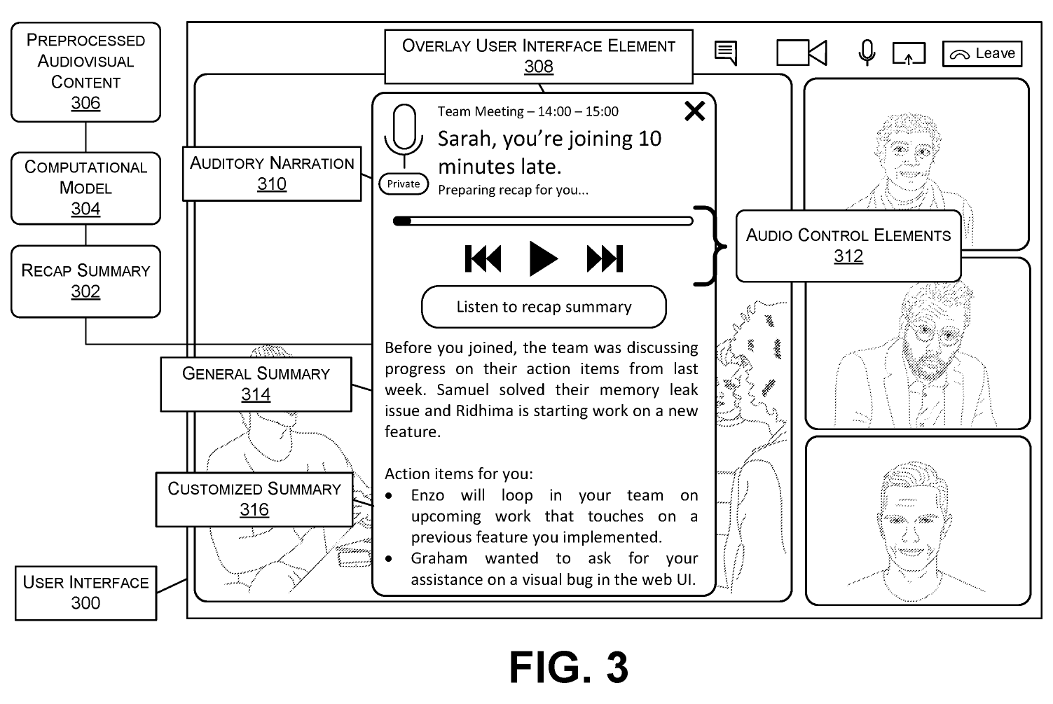

Turning now to FIG. 3, aspects of an example user interface 300 for delivering recap summary 302 in both text and auditory narration formats are shown and described. Similar to the examples described above, the user interface 300 provides an audiovisual feed of an ongoing event (e.g., an online meeting, a livestream, a podcast session). Likewise, the recap summary 302 is generated by a computational model 304 as a summary of preprocessed audiovisual content 306 corresponding to an elapsed portion of an ongoing event. In various examples, the preprocessed audiovisual content 306 is truncated – if needed – in accordance with a threshold duration then transcribed and filtered as described above to remove irrelevant and/or redundant information (e.g., small talk, repeated content).

Similar to the example of FIG. 2 above, the recap summary 302 is delivered by modifying the user interface 300 to render an overlay user interface element 308. As shown, the late-joining user is entering the ongoing event ten minutes late which triggers the generation of the recap summary 302. Moreover, the overlap user interface element 308 delivers the recap summary 302 in multiple formats. In a first format, the overlap user interface element 308 includes an auditory narration 310 of the recap summary 302 that is synthesized by the computational model 304. Accordingly, the overlay user interface element 308 includes a rendering of audio control elements 312 for interacting with the auditory narration 310 (e.g., play/pause, fast forward, rewind, a progress bar).

In addition, the overlay user interface element 308 includes a textual form of the recap summary 302 that is generated by the computational model 304. As illustrated, the overlay user interface element 308 can include a rendering of a general summary 314 providing a broad overview of the ongoing event so far (e.g., “Before you joined, the team was discussing progress on their action items from last week.”). Furthermore, the overlay user interface element 308 can include a customized summary 316 that includes information that is specific to the late-joining user (e.g., “Sarah”).

As mentioned above, the semantic topics of the recap summary 302 can be selected by the computational model 304 based on contextual information such as a role (e.g., a job title) associated with the late-joining user (e.g., a username, a role) to further customize the recap summary 302 to their specific needs. In one example, the user is associated with a technical role (e.g., a software engineer, a system architect). Accordingly, the computational model 304 can prioritize semantic topics that are relevant to the technical role (e.g., discussion of engineering questions).

For example, the customized summary 316 includes an entry stating that “Enzo will loop in your team on upcoming work that touches on a previous feature you implemented.” In various examples, this portion of the customized summary 316 is derived from the preprocessed audiovisual content 306 by the computational model 304 based on contextual information associated with the late-joining user (e.g., Sarah’s role as a member of software engineering team). In another example, the customized summary 316 includes an entry informing the user that “Graham wanted to ask for your assistance on a visual bug in the web UI.” This portion of the customized summary 316 can be deduced by the computational model 304 from the preprocessed audiovisual content 306 based on a mention of the late-joining user’s name (e.g., “Sarah”) within the context of a discussion regarding a specific semantic topic (e.g., “a visual bug in the web UI”). In this way, the recap summary 302 enables a late-joining user to quickly catch up to the ongoing event while also providing customized insights.

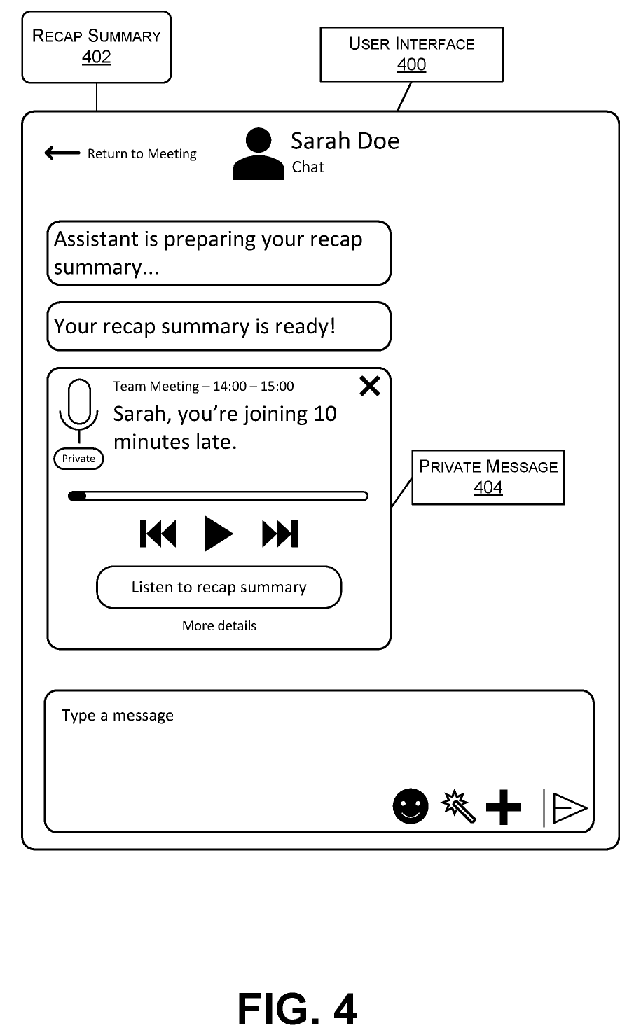

Turning now to FIG. 4, aspects of another example user interface 400 for delivering a recap summary 402 are shown and described. As mentioned above, recap summaries can be delivered in an overlay user interface element as shown and described with respect to FIGS. 2 and 3 and/or as a private message 404 as shown in FIG. 4. In various examples, the user interface 400 is rendered in response to a user input activating a message notification within a user interface of an ongoing event (e.g., an online meeting user interface). Accordingly, the user interface of the ongoing event is modified to transition the late-joining user to a private listening session to deliver the recap summary 402.

In one example, the recap summary 402 is delivered as an auditory narration in which the audiovisual feed of the ongoing event is paused for the late-joining user while the auditory narration is played. Once the auditory narration concludes, the late-joining user can exit the user interface 400. In response, the aforementioned event management module resynchronizes the late-joining user to the ongoing event. In this way, the system can minimize disruptions for users of the ongoing event while the late-joining user catches up. In another example, the recap summary 402 is delivered as a text file in a private message 404. Accordingly, the late-joining user can simultaneously review the recap summary 402 while listening to the ongoing event. In addition, the recap summary 402 can be configured for availability even after the ongoing event concludes.

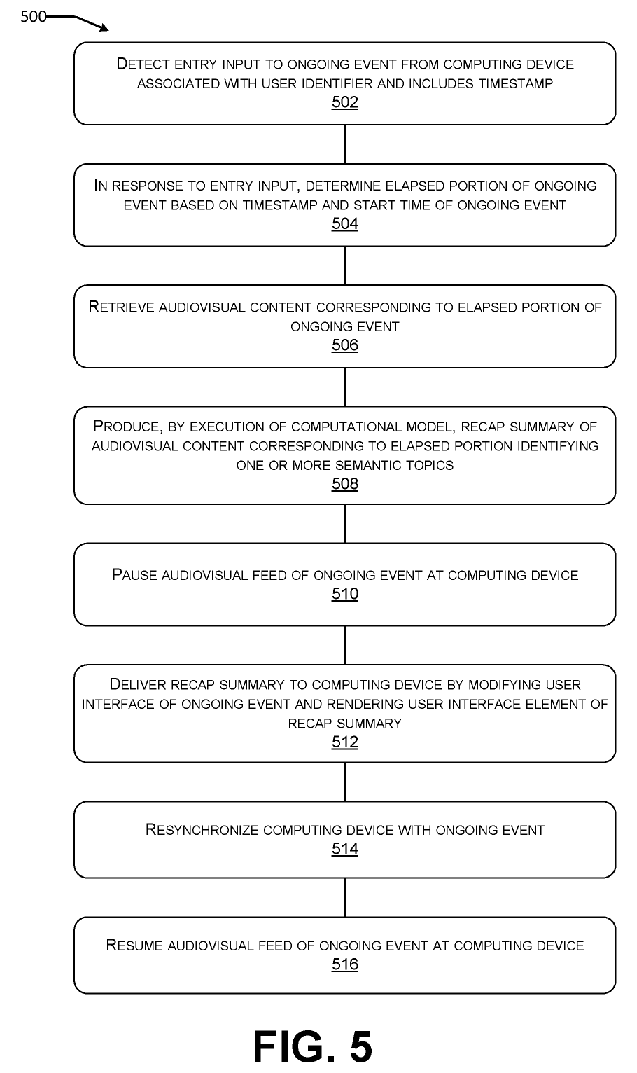

Proceeding to FIG. 5, aspects of a process 500 for generating and delivering recap summaries to late-joining users of an ongoing event are shown and described. With respect to FIG. 5, the process 500 begins at operation 502 where a system (e.g., an event management module) detects an entry input to the ongoing event. As described above, the system can determine that the entry input is received from a computing device that is associated with a user identifier (e.g., a username). Moreover, the entry input can include a timestamp indicating a time at which the entry input was generated. In this way, the system can record the user’s time of entry into the ongoing event.

Accordingly, at operation 504, in response to the entry input, the system determines an elapsed portion of the ongoing event based the timestamp of the entry input and a start time of the ongoing event. For example, given an ongoing event with a start time of “10:00 AM” and an entry input with a timestamp of “10:30 AM”, the elapsed portion is thirty minutes.

Then, at operation 506, the system retrieves audiovisual content corresponding to the elapsed portion of the ongoing event. For example, in an online meeting, the system can retrieve speech audio data, webcam video data, and/or transcript text data covering the elapsed portion. In addition, as described above, the amount of audiovisual data that is retrieved can be configured based on a threshold duration associated with the elapsed portion. For example, a user that is an hour late to an online meeting may not need the entire hour summarized to catch up to the current discussion. Accordingly, a threshold duration of ten minutes can be configured such that the system only retrieves the last ten minutes of the online meeting before the late-joining user arrived.

Next, at operation 508, the system produces, by an execution of a computational model, a recap summary of the audiovisual content corresponding to the elapsed portion of the ongoing event. As discussed above, the recap summary identifies one or more semantic topics conveyed in the audiovisual content (e.g., project milestones, action items for individual users).

Subsequently, at operation 510, the system pauses the audiovisual feed of the ongoing event at the computing device of the late-joining user. In various examples, the audiovisual feed is only paused for the late-joining user and not other users of the ongoing event. In addition, the system may disable certain user input devices (e.g., muting a microphone) while delivering the recap summary to avoid potential disruptions to the ongoing event.

Then, at operation 512, the system delivers the recap summary to the computing device by modifying a user interface of the ongoing event and rendering a user interface element associated with the recap summary. In one example, the user interface element associated with the recap summary is an overlay element that is rendered within the user interface of the ongoing event. In another example, the user interface element associated with the recap summary is a private message that transitions the user interface to a private chat that is only visible to the late-joining user.

Next, at operation 514, the system resynchronizes the computing device to the ongoing event and finally, at operation 516, the system resumes the audiovisual feed of the ongoing event at the computing device. In one example, the ongoing event is an online meeting. Accordingly, resynchronizing comprises returning the late-joining user to the live meeting. In another example, the ongoing event is a podcast session that can be paused on command. Consequently, resynchronizing comprises resuming where the podcast was paused when the user joined the session.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (i) as a sequence of computer implemented acts or program modules running on a computing system and/or (ii) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

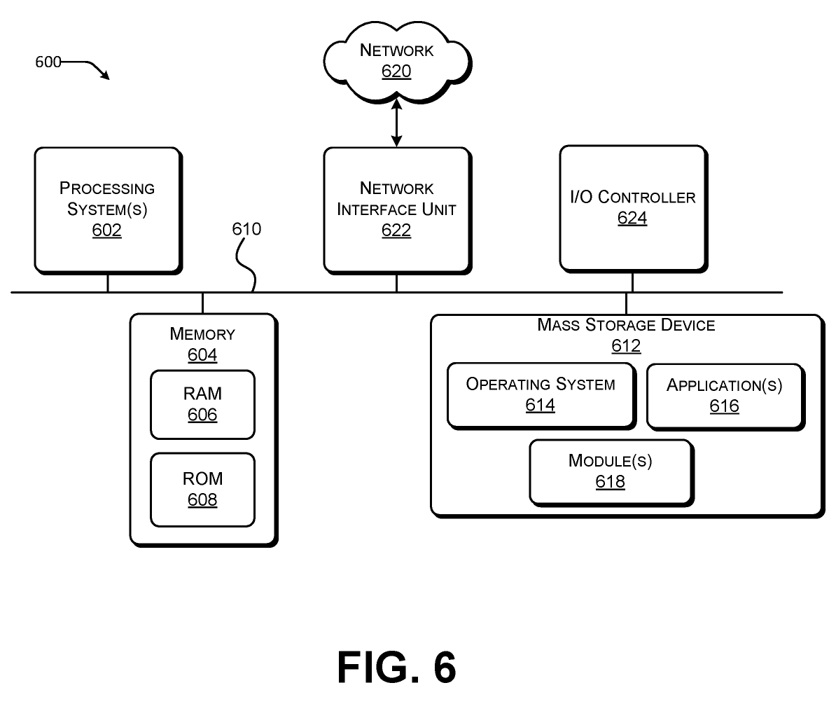

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of a volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.

Example Clause A, A method for delivering a recap summary of an ongoing event, the method comprising: detecting an entry input to the ongoing event, wherein: the entry input is received from a computing device associated with a user identifier; and the entry input includes a timestamp indicating a time at which the entry input was generated; in response to detecting the entry input, determining an elapsed portion of the ongoing event based on the timestamp included in the entry input and a start time of the ongoing event; retrieving audiovisual content corresponding to the elapsed portion of the ongoing event; producing, by an execution of a computational model, the recap summary of the audiovisual content corresponding to the elapsed portion, wherein the recap summary identifies one or more semantic topics conveyed by the audiovisual content; pausing, at the computing device associated with the user identifier, an audiovisual feed of the ongoing event; delivering the recap summary to the computing device associated with the user identifier by: modifying a display of a user interface of the ongoing event; and rendering a user interface element associated with the recap summary; resynchronizing the computing device associated with the user identifier with the ongoing event; and resuming, at computing device associated with the user identifier, the audiovisual feed of the ongoing event.

Example Clause B, the method of Example Clause A, wherein the delivering the recap summary further comprises synthesizing, by the computational model, an auditory narration of the one or more semantic topics conveyed by the audiovisual content.

Example Clause C, the method of Example Clause A, wherein the delivering the recap summary further comprises outputting a text file describing the one or more semantic topics conveyed by the audiovisual content.

Example Clause D, the method of any one of Example Clause A through C, wherein an amount of audiovisual content that is retrieved is configured based on a threshold duration associated with the elapsed portion of the ongoing event.

Example Clause E, the method of any one of Example Clause A through D, wherein retrieving the audiovisual content corresponding to the elapsed portion of the ongoing event comprises: retrieving a transcription of the audiovisual content; and filtering the transcription of the audiovisual content based on a preconfigured priority metric.

Example Clause F, the method of any one of Example Clause A through E, wherein the one or more semantic topics identified by the recap summary are selected by the computational model based on a role associated with the user identifier.

Example Clause G, the method of any one of Example Clause A through F, wherein the user interface element that is integrated with the user interface of the ongoing event comprises a private message.

Example Clause H, the method of any one of Example Clause A through F, wherein the user interface element that is integrated with the user interface of the ongoing event comprises an overlay element.

Example Clause I, a system for delivering a recap summary of an ongoing event, the system comprising: a processing unit; and a computer-readable storage medium having encoded thereon, computer-readable instructions that, when executed by the processing unit, cause the processing unit to perform operations comprising: detecting an entry input to the ongoing event, wherein: the entry input is received from a computing device associated with a user identifier; and the entry input includes a timestamp indicating a time at which the entry input was generated; in response to detecting the entry input, determining an elapsed portion of the ongoing event based on the timestamp included in the entry input and a start time of the ongoing event; retrieving audiovisual content corresponding to the elapsed portion of the ongoing event; producing, by an execution of a computational model, the recap summary of the audiovisual content corresponding to the elapsed portion, wherein the recap summary identifies one or more semantic topics conveyed by the audiovisual content; and delivering the recap summary to the computing device associated with the user identifier by: modifying a display of a user interface of the ongoing event; and rendering an overlay user interface element associated with the recap summary within the display of the user interface of the ongoing event.

Example Clause J, the system of Example Clause I, wherein the delivering the recap summary further comprises synthesizing, by the computational model, an auditory narration of the one or more semantic topics conveyed by the audiovisual content.

Example Clause K, the system of Example Clause J, wherein delivering the recap summary further comprises: pausing, at the computing device associated with the user identifier, an audiovisual feed of the ongoing event; playing the auditory narration of the one or more semantic topics conveyed by the audiovisual content; resynchronizing the computing device associated with the user identifier with the ongoing event; and resuming the audiovisual feed of the ongoing event.

Example Clause L, the system of Example Clause I, wherein the delivering the recap summary further comprises outputting a text file describing the one or more semantic topics conveyed by the audiovisual content.

Example Clause M, the system of any one of Example Clause I through L, wherein an amount of audiovisual content that is retrieved is configured based on a threshold duration associated with the elapsed portion of the ongoing event.

Example Clause N, the system of any one of Example Clause I through M, wherein retrieving the audiovisual content corresponding to the elapsed portion of the ongoing event comprises: retrieving a transcription of the audiovisual content; and filtering the transcription of the audiovisual content based on a preconfigured priority metric.

Example Clause O, the system of any one of Example Clause I through N, wherein the one or more semantic topics identified by the recap summary are selected by the computational model based on a role associated with the user identifier.

Example Clause P, a system for delivering a recap summary of an ongoing event, the system comprising: a processing unit; and a computer-readable storage medium having encoded thereon, computer-readable instructions that, when executed by the processing unit, cause the processing unit to perform operations comprising: detecting an entry input to the ongoing event, wherein: the entry input is received from a computing device associated with a user identifier; and the entry input includes a timestamp indicating a time at which the entry input was generated; in response to detecting the entry input, determining an elapsed portion of the ongoing event based on the timestamp included in the entry input and a start time of the ongoing event; retrieving audiovisual content corresponding to the elapsed portion of the ongoing event; producing, by an execution of a computational model, the recap summary of the audiovisual content corresponding to the elapsed portion, wherein the recap summary identifies one or more semantic topics conveyed by the audiovisual content; and delivering the recap summary to the computing device associated with the user identifier by: modifying a display of a user interface of the ongoing event; and rendering a private message user interface element associated with the recap summary.

Example Clause Q, the system of Example Clause P, wherein the delivering the recap summary further comprises synthesizing, by the computational model, an auditory narration of the one or more semantic topics conveyed by the audiovisual content.

Example Clause R, the system of Example Clause Q, wherein delivering the recap summary further comprises: pausing, at the computing device associated with the user identifier, an audiovisual feed of the ongoing event; playing the auditory narration of the one or more semantic topics conveyed by the audiovisual content; resynchronizing the computing device associated with the user identifier with the ongoing event; and resuming the audiovisual feed of the ongoing event.

Example Clause S, the system of any one of Example Clause P through Example Clause R, wherein the delivering the recap summary comprises outputting a text file describing the one or more semantic topics conveyed by the audiovisual content.

Example Clause T, the system of any one of Example Clause P through Example Clause R, wherein an amount of audiovisual content that is retrieved is configured based on a threshold duration associated with the elapsed portion of the ongoing event.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for delivering a recap summary of an ongoing event, the method comprising:
detecting an entry input to the ongoing event, wherein:
the entry input is received from a computing device associated with a user identifier; and
the entry input includes a timestamp indicating a time at which the entry input was generated;
in response to detecting the entry input, determining an elapsed portion of the ongoing event based on the timestamp included in the entry input and a start time of the ongoing event;
retrieving audiovisual content corresponding to the elapsed portion of the ongoing event;
producing, by an execution of a computational model, the recap summary of the audiovisual content corresponding to the elapsed portion, wherein the recap summary identifies one or more semantic topics conveyed by the audiovisual content;
pausing, at the computing device associated with the user identifier, an audiovisual feed of the ongoing event;
delivering the recap summary to the computing device associated with the user identifier by:
modifying a display of a user interface of the ongoing event; and
rendering a user interface element associated with the recap summary;
resynchronizing the computing device associated with the user identifier with the ongoing event; and
resuming, at computing device associated with the user identifier, the audiovisual feed of the ongoing event.

2. The method of claim 1, wherein the delivering the recap summary further comprises synthesizing, by the computational model, an auditory narration of the one or more semantic topics conveyed by the audiovisual content.

3. The method of claim 1, wherein the delivering the recap summary further comprises outputting a text file describing the one or more semantic topics conveyed by the audiovisual content.

4. The method of claim 1, wherein an amount of audiovisual content that is retrieved is configured based on a threshold duration associated with the elapsed portion of the ongoing event.

5. The method of claim 1, wherein retrieving the audiovisual content corresponding to the elapsed portion of the ongoing event comprises:
retrieving a transcription of the audiovisual content; and
filtering the transcription of the audiovisual content based on a preconfigured priority metric.

6. The method of claim 1, wherein the one or more semantic topics identified by the recap summary are selected by the computational model based on a role associated with the user identifier.

7. The method of claim 1, wherein the user interface element that is integrated with the user interface of the ongoing event comprises a private message.

8. The method of claim 1, wherein the user interface element that is integrated with the user interface of the ongoing event comprises an overlay element.

9. A system for delivering a recap summary of an ongoing event, the system comprising:
a processing unit; and
a computer-readable storage medium having encoded thereon, computer-readable instructions that, when executed by the processing unit, cause the processing unit to perform operations comprising:
detecting an entry input to the ongoing event, wherein:
the entry input is received from a computing device associated with a user identifier; and
the entry input includes a timestamp indicating a time at which the entry input was generated;
in response to detecting the entry input, determining an elapsed portion of the ongoing event based on the timestamp included in the entry input and a start time of the ongoing event;
retrieving audiovisual content corresponding to the elapsed portion of the ongoing event;
producing, by an execution of a computational model, the recap summary of the audiovisual content corresponding to the elapsed portion, wherein the recap summary identifies one or more semantic topics conveyed by the audiovisual content; and
delivering the recap summary to the computing device associated with the user identifier by:
modifying a display of a user interface of the ongoing event; and
rendering an overlay user interface element associated with the recap summary within the display of the user interface of the ongoing event.

10. The system of claim 9, wherein the delivering the recap summary further comprises synthesizing, by the computational model, an auditory narration of the one or more semantic topics conveyed by the audiovisual content.

11. The system of claim 10, wherein delivering the recap summary further comprises:
pausing, at the computing device associated with the user identifier, an audiovisual feed of the ongoing event;
playing the auditory narration of the one or more semantic topics conveyed by the audiovisual content;
resynchronizing the computing device associated with the user identifier with the ongoing event; and
resuming the audiovisual feed of the ongoing event.

12. The system of claim 9, wherein the delivering the recap summary further comprises outputting a text file describing the one or more semantic topics conveyed by the audiovisual content.

13. The system of claim 9, wherein an amount of audiovisual content that is retrieved is configured based on a threshold duration associated with the elapsed portion of the ongoing event.

14. The system of claim 9, wherein retrieving the audiovisual content corresponding to the elapsed portion of the ongoing event comprises:
retrieving a transcription of the audiovisual content; and
filtering the transcription of the audiovisual content based on a preconfigured priority metric.

15. The system of claim 9, wherein the one or more semantic topics identified by the recap summary are selected by the computational model based on a role associated with the user identifier.

16. A system for delivering a recap summary of an ongoing event, the system comprising:
a processing unit; and
a computer-readable storage medium having encoded thereon, computer-readable instructions that, when executed by the processing unit, cause the processing unit to perform operations comprising:
detecting an entry input to the ongoing event, wherein:
the entry input is received from a computing device associated with a user identifier; and
the entry input includes a timestamp indicating a time at which the entry input was generated;
in response to detecting the entry input, determining an elapsed portion of the ongoing event based on the timestamp included in the entry input and a start time of the ongoing event;
retrieving audiovisual content corresponding to the elapsed portion of the ongoing event;
producing, by an execution of a computational model, the recap summary of the audiovisual content corresponding to the elapsed portion, wherein the recap summary identifies one or more semantic topics conveyed by the audiovisual content; and
delivering the recap summary to the computing device associated with the user identifier by:
modifying a display of a user interface of the ongoing event; and
rendering a private message user interface element associated with the recap summary.

17. The system of claim 16, wherein the delivering the recap summary further comprises synthesizing, by the computational model, an auditory narration of the one or more semantic topics conveyed by the audiovisual content.

18. The system of claim 17, wherein delivering the recap summary further comprises:
pausing, at the computing device associated with the user identifier, an audiovisual feed of the ongoing event;
playing the auditory narration of the one or more semantic topics conveyed by the audiovisual content;
resynchronizing the computing device associated with the user identifier with the ongoing event; and
resuming the audiovisual feed of the ongoing event.

19. The system of claim 16, wherein the delivering the recap summary comprises outputting a text file describing the one or more semantic topics conveyed by the audiovisual content.

20. The system of claim 16, wherein an amount of audiovisual content that is retrieved is configured based on a threshold duration associated with the elapsed portion of the ongoing event.
